(19) United States
(12) Patent Application Publication
(10) Pub. No.: US 2012/0231266 A1
(43) Pub. Date: Sep. 13, 2012

(54) ADHESIVE SHEET AND ELECTRONIC COMPONENT

(75) Inventors: Takeshi Saitoh, Shibukawa-city (JP); Tomomichi Takatsu, Shibukawa-city (JP)

(73) Assignee: DENKI KAGAKU KOGYO KABUSHIKI KAISHA, Tokyo (JP)

(21) Appl. No.: 13/510,821

(22) PCT Filed: Nov. 16, 2010
(86) PCT No.: PCT/JP2010/070348

§ 371 Date: May 18, 2012

(30) Foreign Application Priority Data
Nov. 30, 2009 (JP) 2009-271023

(51) Int. Cl. B32B 27/40

(52) U.S. Cl. 428/332; 428/354; 428/425.9

(57) ABSTRACT

Provided are an adhesive sheet having a conductive die attach film that is superior in semiconductor chip-holding efficiency and pick-up efficiency and an electronic component prepared by using the adhesive sheet.

An adhesive sheet, including a base film, an adhesive layer laminated on one face of the base film and a die attach film containing a conductive filler laminated on the adhesive layer, wherein the adhesive layer is shaped from a bonding composition containing a multifunctional isocyanate curing agent: 0.5 to 20 parts by mass with respect to a (meth)acrylic ester copolymer having a carboxyl group-containing monomer's copolymerization rate of less than 0.5%:100 parts by mass.

### TECHNICAL FIELD

The present invention relates to an adhesive sheet and an electronic components prepared by using the adhesive sheet. More specifically, it relates to an adhesive sheet used in the dicing step and the die bonding step during production of electronic components mounted semiconductor chips on.

### BACKGROUND ART

Generally in the dicing step of dicing a semiconductor wafer into chips, an adhesive sheet for dicing is used to protect and fix the wafer during dicing and to hold the diced chips until the pick-up step (see, for example, Patent Document 1). On the other hand, a die-bonding (die attach) film is used to mount the diced semiconductor chip on a substrate or lead frame or to laminate the diced semiconductor chip on another semiconductor chip.

Laminate adhesive sheets consisting of an adhesive sheet and a die attach film, which have the functions of an adhesive sheet for dicing and also of an adhesive agent for fixing semiconductor chips to a lead frame were also proposed (see, for example, Patent Documents 2 to 5).

For example when an electronic component is produced by using such a laminate adhesive sheet, an adhesive sheet carrying a semiconductor wafer fixed thereto is bonded to a ring frame and the semiconductor wafer is diced by using a dicing blade. Subsequently, the adhesive sheet is expanded radially for separation of individual chips, each semiconductor chip carrying the bonded die attach film is picked up and mounted on a substrate, lead frame or the like.

### CITATION LIST

### Patent Literature

[Patent Document 1] Japanese Unexamined Patent Application Publication No. 2006-137816

[Patent Document 2] Japanese Unexamined Patent Application Publication No. 2006-049509

[Patent Document 3] Japanese Unexamined Patent Application Publication No. 2007-246633

[Patent Document 4] Japanese Unexamined Patent Application Publication No. 2010-74144

[Patent Document 5] Japanese Unexamined Patent Application Publication No. 2010-177699

### SUMMARY OF INVENTION

### Technical Problem

However, conventional adhesive sheets, such as those described in Patent Documents 2 to 5, had a problem that addition of a conductive filler to the die attach film for making it conductive leads to deterioration in semiconductor chip-holding efficiency and pick-up efficiency.

Thus, a main object of the present invention is to provide an adhesive sheet having a conductive die attach film that is superior in semiconductor chip-holding efficiency and pick-up efficiency and an electronic component prepared by using the adhesive sheet.

### Solution to Problem

The adhesive sheet according to the present invention comprises a base film, an adhesive layer laminated on one face of the base film and a die attach film containing a conductive filler laminated on the adhesive layer, wherein the adhesive layer contains a (meth)acrylic ester copolymer having a carboxyl group-containing monomer's copolymerization rate of less than 0.5%:100 parts by mass and a multifunctional isocyanate curing agent: 0.5 to 20 parts by mass.

In the adhesive sheet, the adhesive layer may contain additionally a urethane acrylate oligomer having 4 or more vinyl groups: 20 to 200 parts by mass and a silicone-modified acrylic resin: 0.1 to 10 parts by mass.

In addition, the thickness of the adhesive layer may be, for example, 20 to 50 μm.

Further, the conductive filler for use may be, for example, silver, copper, boron nitride or alumina in the pure form or a mixture thereof.

### <Explanation of Terms>

The monomer unit, as used herein, means a structural unit derived from a monomer. The “part” and “%” are values based on mass. The (meth)acrylate is a generic term indicating both acrylate and methacrylate. Compounds containing the term “meth” in the chemical name, such as (meth)acrylic acid, are also the compounds indicating both a “meth”-containing compound and a non-“meth”-containing compound.

The electronic component according to the present invention is that produced by using the adhesive sheet described above.

### Advantageous Effects of Invention

It is possible according to the present invention to make conductive a die attach film without deterioration in semiconductor chip-holding efficiency and pick-up efficiency of the adhesive sheet that is favorably used in production of electronic components.

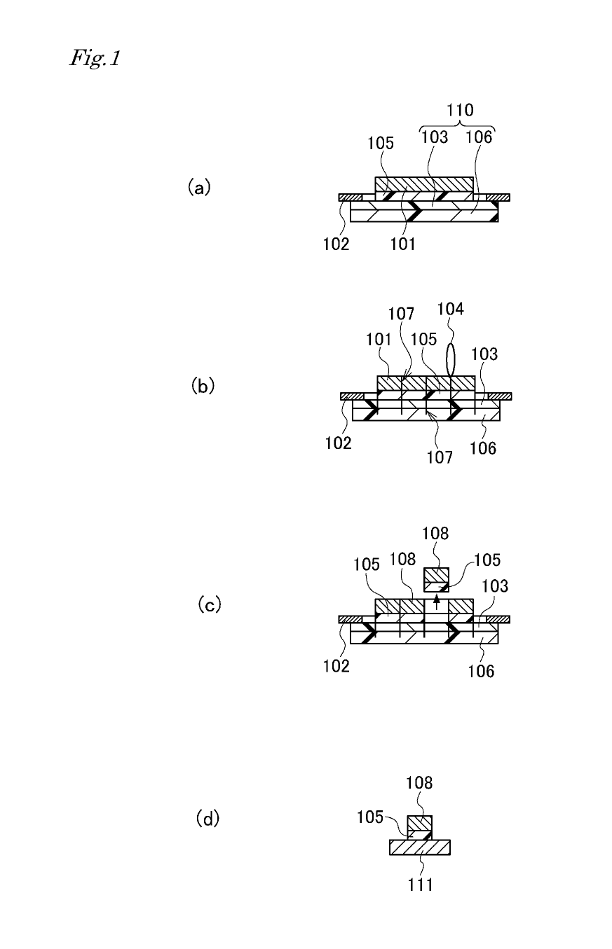

### BRIEF DESCRIPTION OF DRAWINGS

[FIG. 1] FIGS. 1(a) to 1(d) are sectional views respectively showing steps of producing an electronic component in the second embodiment of the present invention in that order.

### DESCRIPTION OF EMBODIMENTS

Hereinafter, favorable embodiments of the present invention will be described in detail with reference to the attached drawings. However, it should be understood that the present invention is not restricted by the following embodiments.

### First Embodiment

First, an adhesive sheet in the first embodiment of the present invention will be described. The adhesive sheet in the present embodiment has a configuration consisting of a base film, an adhesive layer laminated on one face thereof and a die attach film laminated additionally on the adhesive layer. The die attach film contains a conductive filler blended therein. In addition, the adhesive agent constituting the adhesive layer contains a (meth)acrylic ester copolymer: 100 parts by mass and a multifunctional isocyanate curing agent: 0.5 to 20 parts by mass, wherein the copolymerization rate of the carboxyl group-containing monomer in the (meth)acrylic ester copolymer is less than 0.5%.

### [Base Film]

The material for the base film is not particularly limited and examples thereof include polyvinyl chloride, polyethylene terephthalate, ethylene-vinyl acetate copolymers, ethylene-acrylic acid-acrylic ester copolymers, ethylene-ethyl acrylate copolymers, polyethylene, polypropylene, ethylene-acrylate copolymers, and also ionomer resins prepared by crosslinking an ethylene-(meth)acrylate copolymer or an ethylene-(meth)acrylate-(meth)acrylic ester copolymer with metal ions. The base film may be prepared in combination or as a copolymer of these resins and may be a laminate of the films different in composition.

Ionomer resins are preferable among these resins and, in particular, ionomer resins prepared by crosslinking a copolymer having an ethylene unit, a (meth)acrylic acid unit and an alkyl (meth)acrylate unit with metal ions such as Na⁺, K⁺ or Zn²⁺ are preferable. When such an ionomer resin is used for the base film, it is possible to suppress generation of whisker-like scraps during dicing.

In addition, the base film is preferably antistatically treated. It is thus possible to prevent electrification when the die attach film is separated. The method for the antistatic treatment of the base film is not particularly limited, and the antistatic treatment can be performed, for example, by (1) blending an antistatic agent into the composition constituting the base film, (2) coating an antistatic agent on the face of the base film on which the die attach film is laminated, or (3) using electrification treatment, for example by corona discharge.

A quaternary amine salt monomer, for example, can be used as the antistatic agent. Examples of the quaternary amine salt monomers include dimethylaminoethyl (meth)acrylate quaternary chloride salts, diethylaminoethyl (meth)acrylate quaternary chloride salts, methylethylaminoethyl (meth)acrylate quaternary chloride salts, p-dimethylaminostyrene quaternary chloride salts and p-diethylaminostyrene quaternary chloride salts, and in particular, dimethylaminoethyl methacrylate quaternary chloride salts are preferable.

### [Adhesive Layer]

The adhesive agent constituting the adhesive layer contains 100 parts by mass of the (meth)acrylic ester copolymer and 0.5 to 20 parts by mass of the multifunctional isocyanate curing agent. The (meth)acrylic ester copolymer has a carboxyl group-containing monomer's copolymerization rate of less than 0.5%. In addition to the components described above, the adhesive agent constituting the adhesive layer preferably contains a urethane acrylate oligomer having 4 or more vinyl groups in an amount of 20 to 200 parts by mass and a silicone-modified acrylic resin in an amount of 0.1 to 10 parts by mass, as they are blended.

### <(Meth)Acrylic Ester Copolymer: 100 Parts by Mass>

The (meth)acrylic ester copolymer contained in the adhesive layer of the adhesive sheet in the present embodiment is a copolymer consisting of a (meth)acrylic ester (major monomer) and a vinyl compound monomer. The (meth)acrylic ester copolymer is a photocuring pressure-sensitive adhesive, which forms three-dimensional network by irradiation of ultraviolet ray, thus permitting easier separation of the die attach film.

Examples of the main monomer of (meth)acrylic esters include butyl (meth)acrylate, 2-butyl (meth)acrylate, t-butyl (meth)acrylate, pentyl (meth)acrylate, octyl (meth)acrylate, 2-ethylhexyl (meth)acrylate, nonyl (meth)acrylate, decyl (meth)acrylate, lauryl (meth)acrylate, methyl (meth)acrylate, ethyl (meth)acrylate, isopropyl (meth)acrylate, tridecyl (meth)acrylate, myristyl (meth)acrylate, cetyl (meth)acrylate, stearyl (meth)acrylate, cyclohexyl (meth)acrylate, isobornyl (meth)acrylate, dicyclopentanyl (meth)acrylate, benzyl (meth)acrylate, methoxyethyl (meth)acrylate, ethoxyethyl (meth)acrylate, butoxymethyl (meth)acrylate and ethoxy-n-propyl (meth)acrylate and the like.

The vinyl compound monomer for use is, for example, a monomer having one or more functional groups selected from the functional groups consisting of hydroxyl group, carboxyl group, epoxy group, amido group, amino group, methylol group, sulfonic acid group, sulfamic acid group and phosphoric/phosphorous acid groups.

Examples of the hydroxyl group-containing monomers include 2-hydroxyethyl (meth)acrylate, 2-hydroxypropyl (meth)acrylate and 2-hydroxybutyl (meth)acrylate and the like.

Examples of the carboxyl group-containing monomers include (meth)acrylic acid, crotonic acid, maleic acid, maleic anhydride, itaconic acid, fumaric acid, acrylamide N-glycolic acid, cinnamic acid and the like.

Examples of the epoxy group-containing monomers include allyl glycidyl ethers, glycidyl (meth)acrylate ethers and the like.

Examples of the amide group-containing monomers include (meth)acrylamide and the like.

Examples of the amino group-containing monomers include N,N-dimethylaminoethyl (meth)acrylate and the like.

Examples of the methylol group-containing monomers include N-methylol acrylamide and the like.

However, when the carboxyl group-containing monomer's copolymerization rate in the (meth)acrylic ester copolymer is 0.5% or more, the adhesive sheet may become more adhesive to the die attach film by mutual interaction, possibly causing pick-up defects. Thus in the adhesive sheet of the present embodiment, a (meth)acrylic ester copolymer having a carboxyl group-containing monomer's copolymerization rate of less than 0.5% is used.

The methods of producing the (meth)acrylic ester copolymer described above include, for example, emulsion polymerization, solution polymerization and the like, and emulsion polymerization is preferable. It is possible in this way to suppress the interaction with the die attach film and make the die attach film easily separable from the adhesive sheet.

### <Multifunctional Isocyanate Curing Agent: 0.5 to 20 Parts by Mass>

The multifunctional isocyanate curing agent is an isocyanate having two or more isocyanate groups, and examples thereof include aromatic polyisocyanates, aliphatic polyisocyanates, alicyclic polyisocyanates and the like.

Examples of the aromatic polyisocyanates include 1,3-phenylene diisocyanate, 4,4′-diphenyl diisocyanate, 1,4-phenylene diisocyanate, 4,4′-diphenylmethane diisocyanate, 2,4-tolylene diisocyanate, 2,6-tolylene diisocyanate, 4,4′-toluidine diisocyanate, 2,4,6-triisocyanatotoluene, 1,3,5-triisocyanatobenzene, dianisidine diisocyanate, 4,4′-diphenylether diisocyanate, 4,4′,4″-triphenylmethane triisocyanate, ω,ω′-diisocyanato-1,3-dimethylbenzene, ω,ω′-diisocyanato-1,4-dimethylbenzene, ω,ω′-diisocyanato-1,4-diethylbenzene, 1,4-tetramethylxylylene diisocyanate and 1,3-tetramethylxylylene diisocyanate and the like.

Examples of the aliphatic polyisocyanates include trimethylene diisocyanate, tetramethylene diisocyanate, hexamethylene diisocyanate, pentamethylene diisocyanate, 1,2-propylene diisocyanate, 2,3-butylene diisocyanate, 1,3-butylene diisocyanate, dodecamethylene diisocyanate and 2,4,4-trimethylhexamethylene diisocyanate and the like.

Examples of the alicyclic polyisocyanates include 3-isocyanatomethyl-3,5,5-trimethylcyclohexyl isocyanate, 1,3-cyclopentane diisocyanate, 1,3-cyclohexane diisocyanate, 1,4-cyclohexane diisocyanate, methyl-2,4-cyclohexane diisocyanate, methyl-2,6-cyclohexane diisocyanate, 4,4′-methylene bis(cyclohexyl isocyanate), 1,4-bis(isocyanatomethyl)cyclohexane and 1,4-bis(isocyanatomethyl)cyclohexane and the like.

Among these polyisocyanates above, 1,3-phenylene diisocyanate, 4,4′-diphenyl diisocyanate, 1,4-phenylene diisocyanate, 4,4′-diphenylmethane diisocyanate, 2,4-tolylene diisocyanate, 2,6-tolylene diisocyanate, 4,4′-toluidine diisocyanate and hexamethylene diisocyanate are preferable.

However, when the blending rate of the multifunctional isocyanate curing agent is less than 0.5 part by mass with respect to 100 parts by mass of the (meth)acrylic ester copolymer, the adhesive sheet becomes too adhesive, causing pick-up defects. Alternatively when the blending rate of the multifunctional isocyanate curing agent is more than 20 parts by mass with respect to 100 parts by mass of the (meth)acrylic ester copolymer, the adhesive sheet becomes less adhesive, leading to deterioration of the bonding force between the adhesive sheet and the ring frame during dicing. Thus in the adhesive sheet in the present embodiment, the blending rate of the multifunctional isocyanate curing agent is in the range of 0.5 to 20 parts by mass with respect to 100 parts by mass of the (meth)acrylic ester copolymer.

It is thus possible to suppress generation of pick-up defects and also to keep the adhesive sheet and the ring frame bonded to each other during dicing. The blending rate of the multifunctional isocyanate curing agent is more preferably in the range of 1.0 to 10 parts by mass with respect to 100 parts by mass of the (meth)acrylic ester copolymer.

### <Urethane Acrylate Oligomer: 20-200 Parts by Mass>

In the adhesive sheet in the present embodiment, a urethane acrylate oligomer having 4 or more vinyl groups may be added to the adhesive layer in a particular amount for easier separation of the die attach film. The urethane acrylate oligomer having 4 or more vinyl groups (hereinafter, referred to simply as urethane acrylate oligomer) is a (meth)acrylate oligomer having 4 or more vinyl groups and a urethane bond in the molecule.

It is possible, by blending a urethane acrylate oligomer having a vinyl group number of 4 or more, to make the die attach film separated further more easily from the adhesive agent layer when it is cured by UV irradiation. It is thus possible to pick up semiconductor chips easily, as the die attach film is still bonded. When a urethane acrylate oligomer having a vinyl group number of 4 or less is blended into the adhesive layer, it leads to insufficient decrease of the adhesive power after UV irradiation and thus to deterioration of pick-up characteristics instead.

If the urethane acrylate oligomer is blended, the blending amount is preferably in the range of 20 to 200 parts by mass with respect to 100 parts by mass of the (meth)acrylic ester copolymer. When the blending amount of the urethane acrylate oligomer is less than 20 parts by mass, it is not possible to sufficiently obtain the favorable effect of improving the separation efficiency from the adhesive layer after UV irradiation. On the other hand, when the blending amount of the urethane acrylate oligomer is more than 200 parts by mass, it may result in easier generation of pick-up defects by residual of the adhesive during dicing and also of fine stains by the reaction residue. Therefore, when a semiconductor chip carrying the die attach film bonded thereto is mounted on a lead frame, there may be increased adhesion defects under heat.

The urethane acrylate oligomer is an oligomer that is prepared by (a) a reaction between a (meth)acrylate compound having a hydroxyl group and multiple (meth)acrylate groups and a compound having multiple isocyanate groups (e.g., diisocyanate compound) or (b) a reaction between an oligomer having multiple isocyanate terminals, which is previously prepared by reaction of a polyol oligomer having multiple terminal hydroxyl groups and a compound having multiple isocyanate groups (e.g., diisocyanate compound) added in excess, and a (meth)acrylate compound having a hydroxyl group and multiple (meth)acrylate groups.

Examples of the (meth)acrylate compounds having a hydroxyl group and multiple (meth)acrylate groups in the urethane acrylate oligomer (a) include hydroxypropylated trimethylolpropane triacrylate, pentaerythritol triacrylate, dipentaerythritol hydroxypentaacrylate, bis(pentaerythritol) tetraacrylate, tetramethylolmethane triacrylate, glycidol diacrylate, compounds having part or all of these acrylate groups as the methacrylate group, and the like.

On the other hand, the compound having multiple isocyanate groups is, for example, an aromatic isocyanate, an alicyclic isocyanate or an aliphatic isocyanate.

Specifically, examples of the aromatic diisocyanates include tolylene diisocyanate, 4,4-diphenylmethane diisocyanate and xylylene diisocyanate.

Examples of the alicyclic diisocyanates include isophorone diisocyanate and methylene bis(4-cyclohexylisocyanate).

Examples of the aliphatic diisocyanates include hexamethylene diisocyanate and trimethylhexamethylene diisocyanates.

Aromatic or alicyclic isocyanates having multiple isocyanate groups are preferable among these isocyanates. The isocyanate components may be present in the form of monomer, dimer or trimer, but trimers are particularly preferable.

Examples of the polyol components of the polyol oligomer having multiple terminal hydroxyl groups in the urethane acrylate oligomer (b) include poly(propyleneoxide)diol, poly(propyleneoxide)triol, copolymeric (ethyleneoxide-propyleneoxide) diols, poly(tetramethyleneoxide) diols, ethoxylated bisphenol A's, ethoxylated bisphenol S spiroglycols, caprolactone-modified diols and carbonate diols, and the like.

### <Silicone-Modified Acrylic Resin: 0.1 to 10 Parts by Mass>

For easier separation of the die attach film, a silicone-modified acrylic resin may be blended in a particular amount, together with the urethane acrylate oligomer described above, to the adhesive layer of the adhesive sheet in the present embodiment.

The silicone-modified acrylic resin added to the adhesive agent constituting the adhesive layer is preferably a polymer obtained from a (meth)acrylic monomer and a silicone-based macromonomer having vinyl groups at the terminals of polydimethylsiloxane bonds. The silicone-based macromonomer for use is preferably a compound having a vinyl group, such as (meth)acryloyl or styryl, bound to the terminals of polydimethylsiloxane bonds.

The rate of the silicone-based macromonomer unit in the silicone-modified acrylic resin is preferably 15 to 50 parts by mass with respect to 100 parts by mass of the silicone-modified acrylic resin. It is possible in this way to improve the separation efficiency of the die attach film from the adhesive layer and the pick-up efficiency of semiconductor chips after UV irradiation. It is also possible to inhibit bleeding out of the silicone-modified acrylic resin on the adhesive surface and thus to suppress generation of adhesion defects under heat when semiconductor chips with an adhered die attach film are mounted on a lead frame.

Further, the silicone-modified acrylic resin for use is preferably a silicone-modified acrylic resin having a constituent unit derived from at least one compound selected from reactive hydroxyalkyl (meth)acrylates, modified hydroxy (meth)acrylates and vinyl group-containing monomers. It is possible, by using one of these silicone-modified acrylic resins, to prevent generation of fine stains of adhesive residues called particles during pick up of semiconductor chips. It is possible in this way to prevent migration of the silicone-modified acrylic resin into the die attach film even when the adhesive layer and the die attach film are laminated.

The (meth)acrylic monomer, a raw material for the silicone-modified acrylic resin, is for example an alkyl (meth)acrylate, a hydroxyalkyl (meth)acrylate, a modified hydroxy (meth)acrylate or (meth)acrylic acid.

The alkyl (meth)acrylate is, for example, methyl (meth)acrylate, ethyl (meth)acrylate, n-propyl (meth)acrylate, n-butyl (meth)acrylate, isobutyl (meth)acrylate, t-butyl (meth)acrylate, 2-ethylhexyl (meth)acrylate, lauryl (meth)acrylate, stearyl (meth)acrylate, isobornyl (meth)acrylate or hydroxyalkyl (meth)acrylate.

The hydroxyalkyl (meth)acrylate is, for example, hydroxyethyl (meth)acrylate, hydroxypropyl (meth)acrylate or hydroxybutyl (meth)acrylate.

The modified hydroxy (meth)acrylate is, for example, an ethyleneoxide-modified hydroxy (meth)acrylate or a lactone-modified hydroxy (meth)acrylate.

When the silicone-modified acrylic resin described above is blended, the blending amount is preferably 0.1 to 10 parts by mass with respect to 100 parts by mass of the (meth)acrylic ester polymer. When the blending amount of the silicone-modified acrylic resin is less than 0.1 part by mass, it is not possible to sufficiently improve the separation efficiency from the adhesive layer after UV irradiation. On the other hand, when the blending amount of the silicone-modified acrylic resin is more than 10 parts by mass, the initial drop of the adhesive power is magnified and the chips may be easily separated from the ring frame during dicing.

### <Other Components>

The adhesive layer of the adhesive sheet in the present embodiment may contain additives such as polymerization initiators, softeners, aging inhibitors, fillers, ultraviolet absorbents and photostabilizers in the range that does not affect the other components.

<Thickness: 5 to 100 μm>

When the thickness of the adhesive layer is less than 5 μm, the adhesive layer may become less adhesive, leading to deterioration of the bonding force between the adhesive sheet and the ring frame during dicing. Alternatively when the thickness of the adhesive layer is more than 100 μm, the adhesive layer may become too adhesive, leading to generation of pick-up defects. Thus, the thickness of the adhesive layer is preferably 5 to 100 μm. The thickness of the adhesive layer is more preferably in the range of 20 to 50 μm and it is possible to improve both the semiconductor chip-holding efficiency and pick-up efficiency in a balanced manner when the thickness is in the range above.

### [Die Attach Film]

The die attach film used in the adhesive sheet in the present embodiment is a film-shaped adhesive composition that contains a conductive filler. Examples of the compositions constituting the die attach film include acrylic, polyamide-based, polyethylene-based, polysulfone-based, epoxy-based, polyimide-based, polyamide acid-based, silicone-based, phenol-based and rubber-based polymers, fluorine rubber-based polymers, fluoroplastics, the mixtures or copolymers thereof, and the like. Alternatively the die attach film may be a laminate of multiple films different in composition. Further, the adhesive composition may contain additionally photopolymerization initiators, antistatic agents and crosslinking accelerators.

### <Conductive Filler>

On the other hand, a conductive filler is added to the die attach film to make it conductive and to improve its heat releasability. The conductive filler for use may be, for example, silver, copper, boron nitride, alumina, gold, palladium or nickel in the form of pure material or a mixture of them. The conductive filler for use is preferably silver, copper, boron nitride or alumina from the points of reliability, heat-release characteristics and cost.

On the other hand, the blending amount of the conductive filler is preferably in the range of 10 to 1900 parts by mass with respect to 100 parts by mass of the resin components in the adhesive agent composition constituting the die attach film. It is because, when the blending amount of the conductive filler is less than 10 parts by mass, the die attach film may have insufficient heat-release characteristics, and alternatively when the blending amount is more than 1900 parts by mass, it becomes brittler, leading to deterioration in film-forming efficiency.

The adhesive sheet in the present embodiment can be prepared for example by applying an adhesive on a base film to give an adhesive layer and bonding a die attach film prepared separately onto the adhesive layer. In such a case, it is needed to adjust the bonding strength between the die attach film and the adhesive layer. Larger bonding strength between the die attach film and the adhesive layer may lead to increased generation of pick-up defects, while smaller bonding strength may lead to deterioration in chip-holding efficiency. Specifically, the bonding strength between the die attach film and the adhesive layer is preferably 0.05 to 0.9 N/20 mm.

As described above in detail, because the die attach film contains a conductive filler and the copolymerization rate of the carboxyl group-containing monomer in the (meth)acrylic ester copolymer contained in the adhesive layer is adjusted to be less than 0.5% in the adhesive sheet in the present embodiment, it is possible to make the die attach film conductive without deterioration in semiconductor chip-holding efficiency or pick-up efficiency.

### Second Embodiment

Hereinafter, an electronic component in the second embodiment of the present invention will be described. The electronic component in the present embodiment has semiconductor chips and others that are mounted by using the adhesive sheet of the first embodiment described above. FIGS. 1(a) to 1(d) are sectional views showing the steps for production of the electronic component in the present embodiment in that order.

As shown in FIG. 1(a), first in production of the electronic component in the present embodiment, a silicon wafer 101 is bonded to an adhesive sheet 110 in a bonding step and the adhesive sheet 110 is fixed to a ring frame 102 in a fixing step (step S1). Then as shown in FIG. 1(b), the silicon wafer 101 is diced with a dicing blade 104 into semiconductor chips 108 in a dicing step (step S2)

Then, the adhesive sheet 110 is expanded radially to make the semiconductor chips 108 separated from each other in an expanding step (step S3) and, in that state, the semiconductor chips 108 are picked up by adsorption with a vacuum collet (step S4). As shown in FIG. 1(c), in the pick-up step S4, the adhesive layer 103 and the die attach film 105 are separated from each other, and semiconductor chips 108 having the die attach film 105 bonded thereto are picked up.

Then as shown in FIG. 1(d), the semiconductor chip 108 carrying the die attach film 105 bonded thereto is mounted, for example, on a lead frame 111 in a mounting step (step S5). Subsequently, the semiconductor chip 108 and the lead frame 111 are bonded to each other under heat, as the die attach film 105 is heated, in a heat-bonding step (step S6) and the semiconductor chip 108 mounted on the lead frame 111 or the circuit board is molded with a resin (not shown in the Figure) in a molding step (step S7).

Because the electronic component in the present embodiment contains the adhesive sheet described in the first embodiment, the semiconductor chips are both held and picked up efficiently in the production process.

### EXAMPLES

Hereinafter, the advantageous effects of the present invention will be described more specifically with reference to Examples and Comparative Examples of the present invention. However, it should be understood that the present invention is not restricted by theses Examples. In the following Examples, the adhesive sheets of Examples 1 to 13 and Comparative Examples 1 to 7 were prepared and the properties thereof evaluated by the methods and the conditions shown below.

Specifically, each of the adhesives in the compositions shown in the following Tables 1 and 2 was first coated on a polyethylene terephthalate separator film to a adhesive layer thickness of 20 μm after drying. Then, the adhesive layer was laminated on a base film and a die attach film, which was previously cut into a circular form having a diameter of 6.2 inch φ, was laminated on the adhesive layer, to give each of the adhesive sheets of Examples and Comparative Examples.

TABLE 1

| | | | Example | | | | | | | | | | | | |
|---|---|---|---|---|---|---|---|---|---|---|---|---|---|---|---|
| | | | 1 | 2 | 3 | 4 | 5 | 6 | 7 | 8 | 9 | 10 | 11 | 12 | 13 |
| Adhesive | (Meth)acrylic ester | A | 100 | 100 | 100 | — | — | — | — | — | 100 | 100 | 100 | 100 | 100 |
| layer | copolymer | B | — | — | — | 100 | 100 | 100 | 100 | 100 | — | — | — | — | — |
| | (part by mass) | C | — | — | — | — | — | — | — | — | — | — | — | — | — |
| | Multifunctional | A | 5 | 0.5 | 20 | 3 | 3 | 3 | 3 | 3 | 5 | 5 | 5 | 5 | 5 |
| | isocyanate | | | | | | | | | | | | | | |
| | curing agent | | | | | | | | | | | | | | |
| | (part by mass) | | | | | | | | | | | | | | |
| | Urethane acrylate | A | — | — | — | 40 | 20 | 200 | 40 | 40 | — | — | — | — | — |
| | oligomer | B | — | — | — | — | — | — | — | — | — | — | — | — | — |
| | (part by mass) | | | | | | | | | | | | | | |
| | Silicone-modified | A | — | — | — | 2 | 2 | 2 | 0.1 | 10 | — | — | — | — | — |
| | acrylic resin | | | | | | | | | | | | | | |
| | (part by mass) | | | | | | | | | | | | | | |

| | Photopolymerization | — | — | — | 3 | 1.5 | 15 | 3 | 3 | — | — | — | — | — |
|---|---|---|---|---|---|---|---|---|---|---|---|---|---|---|
| | initiator | | | | | | | | | | | | | |
| | (part by mass) | | | | | | | | | | | | | |
| | Thickness (μm) | 30 | 30 | 30 | 30 | 30 | 30 | 30 | 30 | 10 | 60 | 30 | 30 | 30 |
| Die attach film | | A | A | A | A | A | A | A | A | A | A | B | C | D |
| Evaluation | Chip-holding efficiency | ⊙ | ⊙ | ◯ | ⊙ | ◯ | ⊙ | ⊙ | ◯ | ◯ | ⊙ | ⊙ | ⊙ | ⊙ |
| | Pick-up efficiency | ⊙ | ◯ | ⊙ | ⊙ | ◯ | ⊙ | ◯ | ⊙ | ⊙ | ◯ | ⊙ | ⊙ | ◯ |
| | Overall rating | ⊙ | ◯ | ◯ | ⊙ | ◯ | ⊙ | ◯ | ◯ | ◯ | ◯ | ⊙ | ⊙ | ◯ |

TABLE 2

| | | | Comparative Example | | | | | | |
|---|---|---|---|---|---|---|---|---|---|
| | | | 1 | 2 | 3 | 4 | 5 | 6 | 7 |
| Adhesive | (Meth)acrylic ester | A | 100 | 100 | — | — | — | — | — |
| layer | copolymer | B | — | — | — | 100 | 100 | 100 | — |
| | (part by mass) | C | — | — | 100 | — | — | — | 100 |
| | Multifunctional | A | 0.3 | 25 | 5 | 3 | 3 | 3 | 3 |
| | isocyanate | | | | | | | | |
| | curing agent | | | | | | | | |
| | (part by mass) | | | | | | | | |
| | Urethane acrylate | A | — | — | — | 250 | — | 40 | 40 |
| | oligomer | B | — | — | — | — | 40 | — | — |
| | (part by mass) | | | | | | | | |
| | Silicone-modified | A | — | — | — | 2 | 2 | 20 | 2 |
| | acrylic resin | | | | | | | | |
| | (part by mass) | | | | | | | | |

| | Photopolymerization | — | — | — | 18 | 3 | 3 | 3 |
|---|---|---|---|---|---|---|---|---|
| | initiator | | | | | | | |
| | (part by mass) | | | | | | | |
| | Thickness (μm) | 30 | 30 | 30 | 30 | 30 | 30 | 30 |
| Die attach film | | A | A | A | A | A | A | A |
| Evaluation | Chip-holding efficiency | ⊙ | X | ⊙ | X | ⊙ | X | ⊙ |
| | Pick-up efficiency | X | ◯ | X | X | X | ⊙ | X |
| | Overall rating | X | X | X | X | X | X | X |

Then, the base film used in all Examples and Comparative Examples was an ionomer resin film available from Du Pont-Mitsui Polychemicals. Specifically, it is a film of an ionomer resin mainly made of a Zn salt of ethylene-methacrylic acid-alkyl methacrylic ester copolymer that contains Zn²⁺ ions and has a MFR (melt flow rate) of 1.5 g/10 minute (JIS K7210, 210° C.), a melting point of 96° C. and a thickness of 80 μm.

The components contained in the adhesive layer are as follows:

### <(Meth)Acrylic Ester Copolymers>

A: SK Dyne 1496 from Soken Chemical & Engineering Co., Ltd.

A copolymer prepared by solution polymerization of 2-ethylhexyl acrylate: 95 mass % and 2-hydroxyethyl acrylate: 5 mass %. No carboxyl group contained.

B: AR53L from Zeon Corporation

A copolymer prepared by suspension polymerization of ethyl acrylate: 40 mass %, butyl acrylate: 23 mass % and methoxyethyl acrylate: 37 mass %. No carboxyl group contained.

C: SK Dyne 1305H from Soken Chemical & Engineering Co., Ltd.

A copolymer prepared by solution polymerization of butyl acrylate: 65 mass %, methyl acrylate: 25 mass % and acrylic acid: 5 mass %. Carboxyl groups contained (monomer copolymerization rate: 5%)

### <Multifunctional Isocyanate Curing Agent>

A: Coronate L-45E (registered trade name) from Nippon Polyurethane Industry Co., Ltd.

A trimethylolpropane adduct of 2,4-tolylene diisocyanate

### <Urethane Acrylate Oligomers Having 4 or More Vinyl Groups>

It is indicated simply as a urethane acrylate oligomer in Tables 1 and 2.

A: UN-3320HS from Negami Chemical Industrial Co., Ltd.

A terminal-acrylate oligomer obtained in reaction of a terminal isocyanate oligomer prepared in reaction of isophorone diisocyanate (alicyclic diisocyanate) trimer with dipentaerythritol pentaacrylate, having a number-average molecular weight of 3700 and an acrylate functionality of 15.

B: UA-340P from Shin-Nakamura Chemical Co., Ltd.

A terminal acrylate oligomer obtained in reaction of a terminal isocyanate oligomer, which is previously prepared in reaction of the terminals of poly(propylene glycol) diol with isophorone diisocyanate, with 2-hydroxyethyl acrylate, having a number-average molecular weight of 13000 and vinyl functionality of 2 per molecule.

### <Silicone-Modified Acrylic Resins>

A: UTMM-LS2 from Soken Chemical & Engineering Co., Ltd.

A silicone-based graft copolymer obtained by polymerization of acrylic vinyl units such as of methyl methacrylate with silicone-based oligomer units having (meth)acryloyl groups at the silicone chain terminals.

### <Die Attach Films>

A: a film containing a silver filler in an amount of 400 parts by mass with respect to 100 parts by mass of the resin components mainly including the epoxy adhesive agent and having a thickness of 30 μm.
B: a film containing a boron nitride filler in an amount of 400 parts by mass with respect to 100 parts by mass of the resin components mainly including the epoxy adhesive agent and having a thickness of 30 μm.
C: a film containing an alumina filler in an amount of 400 parts by mass with respect to 100 parts by mass of the resin components mainly including the epoxy adhesive agent and having a thickness of 30 μm.
D: a film containing a nickel filler in an amount of 400 parts by mass with respect to 100 parts by mass of the resin components mainly including the epoxy adhesive agent and having a thickness of 30 μm.

### <Photopolymerization Initiator>

The photopolymerization initiator used was benzyldimethyl ketal, specifically Irgacure 651 (registered trade name) available from Ciba Specialty Chemicals Inc.

Then, an electronic component was prepared in the following steps S1 to S7, similarly to the production of the electronic components in the second embodiment, by using each of the adhesive sheets prepared in Examples and Comparative Examples and by the methods and conditions described above. The semiconductor chip-holding efficiency and the pick-up efficiency of each of the adhesive sheets obtained in Examples and Comparative Examples were evaluated.

### Step S1:

A silicon wafer 101 and an adhesive sheet 110 were bonded to each other in a bonding step and the adhesive sheet 110 and a ring frame 102 were fixed to each other in a fixing step simultaneously (see FIG. 1(a)). The silicon wafer 101 used then was a silicon wafer having a diameter of 8 inch and a thickness of 0.3 mm and carrying a dummy circuit pattern formed thereon.

### Step S2:

The silicon wafer 101 was diced with a dicing blade 104 to form semiconductor chips 108 having a chip size of 6 mm×6 mm in a dicing step (see FIG. 1(b)). The major dicing conditions are as follows:

Dicing depth 107 into the adhesive sheet 110: 15 μm
Dicing machine: DAD341 from DISCO Corporation
Dicing blade: NBC-ZH2050-27HEEE from DISCO Corporation
Dicing blade shape: external diameter: 55.56 mm, blade width: 35 μm,
internal diameter: 19.05 mm
Dicing blade rotating speed: 40,000 rpm
Dicing blade feed rate: 50 mm/second
Dicing water temperature: 25° C.
Dicing water quantity: 1.0 L/minute

### Step S3:

The adhesive sheet 110 was expanded radially, for separation of semiconductor chips 108 from each other in an expanding step (not shown in the Figure). The expansion distance then was 8 mm.

### Step S4:

The semiconductor chip 108 was pushed upward with a needle pin (not shown in the Figure) and adsorbed with a vacuum collet (not shown in the Figure) and the adhesive layer 103 and the die attach film 105 were separated from each other between them, allowing pick up of the semiconductor chip 108 carrying the die attach film 105 bonded thereto in a pick-up step (see FIG. 1(c)). The major pick-up conditions are as follows:

Pick-up machine: CAP-300II from Canon Machinery Inc.
Needle pin shape: 250 μmR
Needle pin-pushing height: 0.5 mm

### Step S5:

The semiconductor chip 108 carrying a die attach film 105 bonded thereto was mounted on a lead frame 111 in a mounting step (see FIG. 1(d)).

### Step S6:

The semiconductor chip 108 and the lead frame 111 were bonded to each other under heat, as the die attach film 105 was heated in a heat-bonding step (not shown in the Figure).

### Step S7:

The semiconductor chip 108 mounted on the lead frame 111 was molded with a resin (not shown in the Figure) in a molding step (not shown in the Figure).

The chip-holding efficiency and the pick-up efficiency were evaluated according to the criteria shown below:

### <Chip-Holding Efficiency>

The chip-holding efficiency was evaluated, based on the rate of the semiconductor chips 108 remaining on the adhesive sheet 110 after the step S3 of dicing the semiconductor chip 108.

⊙ (favorable): chip loss of less than 5%
◯ (good): chip loss of 5% or more and less than 10%
x (unfavorable): chip loss of 10% or more

### <Pick-Up Efficiency>

The pick-up efficiency was evaluated, based on the pick-up rate in the pick-up step of step S5.

⊙ (favorable): chip pick-up rate of 95% or more
◯ (good): chip pick-up rate of 80% or more and less than 95%
x (unfavorable): chip pick-up rate of less than 80%

The results above are summarized in Tables 1 and 2. As shown in Tables 1 and 2, the adhesive sheet of Comparative Example 1, which contains the multifunctional isocyanate curing agent in an amount of less than 0.5 part by mass, was lower in pick-up efficiency. On the other hand, the adhesive sheet of Comparative Example 2, which contained the multifunctional isocyanate curing agent in an amount of more than 20 parts by mass, showed lower chip-holding efficiency.

Also, the adhesive sheet of Comparative Examples 3 and 7, which were prepared by using a (meth)acrylic ester copolymer having a carboxyl group-containing monomer's copolymerization rate of 0.5% or more, were both lower in pick-up efficiency, while the adhesive sheet of Comparative Example 4, which contains a urethane acrylate oligomer in an amount of more than 200 parts by mass, was lower both in chip-holding efficiency and pick-up efficiency.

In addition, the adhesive sheet of Comparative Example 5, which contains an added urethane acrylate oligomer having a vinyl group functionality of less than 4, was lower in pick-up efficiency. Further, the adhesive sheet of Comparative Example 6, which contains an added silicone-modified acrylic resin in an amount of more than 10 parts by mass, was lower in chip-holding efficiency.

In contrast, the adhesive sheets of Examples 1 to 13 prepared within the technical scope of the present invention were superior both in chip-holding efficiency and pick-up efficiency. The results above show that it is possible according to the present invention to obtain an adhesive sheet having a conductive die attach film that is superior in semiconductor chip-holding efficiency and pick-up efficiency.

### REFERENCE SIGNS LIST

101: Silicon wafer
102: Ring frame
103: Adhesive layer
104: Dicing blade
107: Dicing depth
105: Die attach film
106: Base film
108: Semiconductor chip
110: Adhesive sheet
111: Lead frame

1. An adhesive sheet, comprising
a base film,
an adhesive layer laminated on one face of the base film and
a die attach film containing a conductive filler laminated on the adhesive layer, wherein
the adhesive layer contains
a (meth)acrylic ester copolymer having a carboxyl group-containing monomer's copolymerization rate of less than 0.5%:100 parts by mass and
a multifunctional isocyanate curing agent: 0.5 to 20 parts by mass.

2. The adhesive sheet according to claim 1, wherein the adhesive layer contains additionally
a urethane acrylate oligomer having 4 or more vinyl groups: 20 to 200 parts by mass and
a silicone-modified acrylic resin: 0.1 to 10 parts by mass.

3. The adhesive sheet according to claim 1, wherein the thickness of the adhesive layer is 20 to 50 μm.

4. The adhesive sheet according to claim 1, wherein the conductive filler is silver, copper, boron nitride or alumina in the pure form or a mixture thereof.

5. An electronic component, prepared by using the adhesive sheet according to claim 1.
